(19) United States
(12) Patent Application Publication
(10) Pub. No.: US 2002/0161703 A1
(43) Pub. Date: Oct. 31, 2002

(54) Mobile radio apparatus

(76) Inventors: Seiichi Okamoto, Tokyo (JP); Keiji Uehara, Tokyo (JP); Koichi Ito, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/926,080

(22) PCT Filed: Dec. 26, 2000
(86) PCT No.: PCT/JP00/09258

(30) Foreign Application Priority Data
Dec. 27, 1999 (JP) 11-369765

(51) Int. Cl. G06F 17/60

(52) U.S. Cl. 705/40

(57) ABSTRACT

In a control unit (100), a W-CDMA radio unit(102) is controlled and information on electronic money is loaded from an electronic money server managed and run by a bank or the like into an UIM card (114) via a W-CDMA communication network. Then, in the control unit (100), a BT radio unit (105) is controlled and an identification number of a commodity and electronic money information equivalent to the price of the commodity are transmitted to a vending machine with a BT communication function capable of conducting electronic commerce When mobile radio apparatus receives information on the acceptance of sale of the commodity from the vending machine, information on electronic money equivalent to the amount of user's dues may be subtracted from the UIM card (114). Therefore, it is possible to provide mobile radio apparatus that assures the user a great convenience in conducting electronic commerce.

### TECHNICAL FIELD

This invention relates to a mobile radio apparatus used in a mobile communication system, and more particularly to a mobile radio apparatus used in such a mobile communication system as a cellular phone system or PHS (Personal Handyphone System).

### BACKGROUND ART

As is generally known, the development of a radio system using the IrDA (Infrared Data Association) standard for transferring data by means of infrared rays is in progress as a radio system dealing with EC (electronic commerce).

In the case of the radio system using infrared rays, the directivity of infrared rays used is high because of the characteristic of IrDA. Thus, when an obstruction blocks the communication between the transmitting unit and the receiving unit, there is strong possibility that they cannot communicate with each other. Accordingly, use of a radio system using the IrDA standard in electronic commerce results in the problem of decreasing user's convenience.

### DISCLOSURE OF INVENTION

The object of the present invention is to provide a mobile radio apparatus that assures a user great convenience in conducting electronic commerce.

According to the present invention, there is provided a mobile radio apparatus for communicating over a radio channel with a base station connectable to a network for communication, comprising:

first communication means for communicating indirectly over a radio channel with a communication apparatus to be communicated through a base station;

second communication means for communicating directly over a radio channel with a communication apparatus using radio waves of lower radio transmission power than the first communication means; and

electronic money payment means for transmitting information on electronic money to the communication apparatus, and for making payments in electronic money, the electronic money payment means communicating with the communication apparatus capable of conducting electronic commerce by the second communication means.

The mobile radio apparatus with the above configuration communicates over a radio channel with the communication apparatus capable of conducting electronic commerce through the second communication means that communicates directly over a radio channel with the communication apparatus, transmits information on electronic money via radio channels, and makes payments in electronic money.

Therefore, since the mobile radio apparatus enables electronic commerce to be conducted by means of the second communication means that communicates directly over a radio channel with the communication apparatus using radio waves of low radio transmission power, communication is less liable to be interfered with by obstruction as when infrared rays are used and the user's convenience is improved in conducting electronic commerce.

Furthermore, according to the present invention, there is provided a mobile radio apparatus for communicating over a radio channel with a base station connectable to a network for communication, comprising:

first communication means for communicating indirectly over a radio channel with a communication apparatus to be communicated through a base station, the first communication means communicating with the base station;

second communication means for communicating directly over a radio channel with a communication apparatus using lower radio transmission power than the first communication means;

first electronic money storage means for storing information on electronic money, and for storing subscriber's information with which communication by the first communication means can be established;

second electronic money storage means for storing information on electronic money, the second electronic money storage means storing the information with a different standard from a standard of the first electronic money storage means; and

electronic money payment means for transmitting the information on electronic money stored in at least one of the first electronic money storage means and second electronic money storage means to the communication apparatus, and for making payments in electronic money, the electronic money payment means communicating with the communication apparatus capable of conducting electronic commerce by the second communication means.

Therefore, since the mobile radio apparatus with the above configuration enables electronic commerce to be conducted by means of the second communication means that communicates directly over a radio channel with the communication apparatus using radio waves of low radio transmission power, communication is less liable to be interfered with by obstruction when infrared rays are used. In addition, payments can be made from at least one of the pieces of information on electronic money stored in the two different storage means. Therefore, the user's convenience is improved in conducting electronic commerce.

### BRIEF DESCRIPTION OF DRAWINGS

FIG. 1 is a functional block diagram of a mobile radio apparatus according to a first embodiment of the present invention;

FIG. 2 shows a system configuration of a case where electronic commerce is conducted using the mobile radio apparatus shown in FIG. 1;

FIG. 3 is a flowchart to help explain the processing in a case where information on electronic money is loaded into an UIM card in the mobile radio apparatus shown in FIG. 1;

FIG. 4 is a flowchart to help explain the processing in a case where a commodity is purchased from a vending machine corresponding to an EC system in the mobile radio apparatus shown in FIG. 1;

FIG. 5 shows a case where the menu information in a step 4d of FIG. 4 is displayed on the display unit of the mobile radio apparatus shown in FIG. 1;

FIG. 6 is a functional block diagram of a mobile radio apparatus according to a second embodiment of the present invention;

FIG. 7 shows an example of inserting a card-type large-capacity memory into the mobile radio apparatus shown in FIG. 6;

FIG. 8 shows a system configuration of a case where electronic commerce is conducted using the mobile radio apparatus shown in FIG. 6;

FIG. 9 is a flowchart for the process of carrying out the operation in a case where the mobile radio apparatus is used to read out information on electronic money from the electronic money server of FIG. 8 into a card-type large-capacity memory;

FIG. 10 is a pictorial diagram showing a case where the card-type large-capacity memory shown in FIG. 7 is inserted into a card slot of an ATM that is capable of inputting and outputting money in the form of electronic money;

FIG. 11 is a flowchart to help explain the processing in a case where information on electronic money is loaded into a card-type large-capacity memory in the ATM shown in FIG. 10; and

FIG. 12 is a flowchart for the processing in the mobile radio apparatus to carry out the operation in a case where a commodity is purchased from the vending machine shown in FIG. 8.

### BEST MODE FOR CARRYING OUT OF THE INVENTION

Hereinafter, referring to the accompanying drawings, embodiments of the present invention will be explained.

A mobile radio apparatus according to a first embodiment of the present invention is provided with a W-CDMA (wideband code division multiple access) radio communication function and a BT (Bluetooth) radio communication function.

In the W-CDMA radio communication, for example, a bandwidth of 5 MHz is used in a 2-GHz band, enabling a high-speed, large-capacity multimedia mobile communication. In the W-CDMA radio communication, a mobile radio apparatus is synchronized with base stations BS (Base Stations) connected to a public telecommunication network and then communication is implemented. The base stations are distributed in a service area of radio communication by the W-CDMA.

The system of the W-CDMA radio communication is used as the radio access method between a base station and a mobile radio apparatus. The following three types, DS-FDD (direct sequence-frequency division duplex), MC-FDD (multi-carrier-frequency division duplex), and TDD (time division duplex), are selectively used as an upward and a downward multiplex system.

In contrast, in the BT radio communication, the ISM band in the 2.4-GMz band is used and radio communication is effected at a weak output signal of 10 mW on the average (a maximum of 100 mW) as compared with the W-CDMA radio communication. This output signal enables radio communication to be implemented in a short distance within 10 m or less. The BT radio communication is generally used as a method of connecting a personal computer with a peripheral device, such as a printer. In this invention, the BT radio communication is used for communication between an apparatus corresponding to an EC system and a mobile radio apparatus.

In the BT radio communication, to enable communication even in an environment where there are many noises, a frequency hopping method with the hopping frequency set at about 1600 hops/sec is used as a radio communication method. Radio communication via asynchronous channels is possible between the calling party and called party, with the transfer speed being 1 Mbps (bits per second) on the whole.

Furthermore, in the BT radio communication, up to eight units can be connected within the range of 10 m or less. These units forms a network called a Piconet, where one unit functions as a master and the remaining ones function as slaves. The units in the Piconet are connected and certified using a code number called a PIN (personal identification number) code.

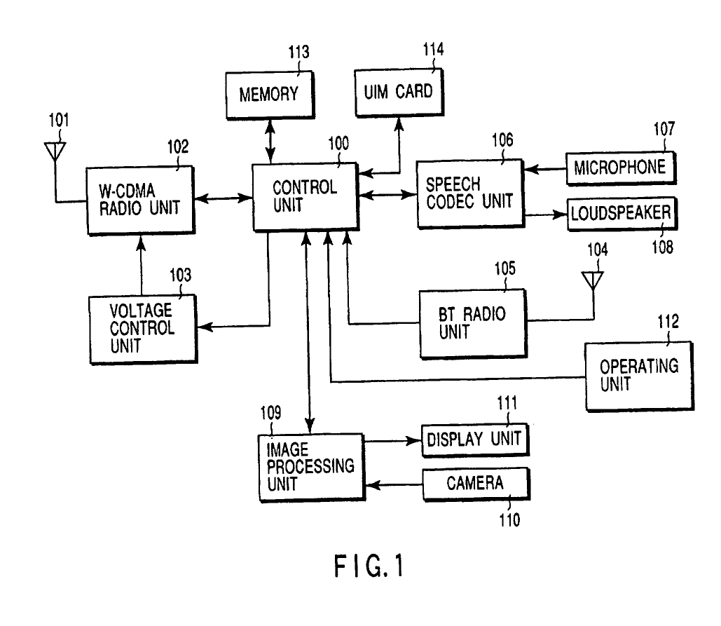

The mobile radio apparatus according to the first embodiment provided with two radio communication systems, the W-CDMA radio communication and the BT radio communication, is constructed as shown in, for example, FIG. 1.

FIG. 1 is a functional block diagram of the mobile radio apparatus according to the first embodiment of the present invention.

A W-CDMA radio unit 102 transmits and receives a CDMA signal to and from a base station BS via an antenna 101 by the W-CDMA radio communication. In the W-CDMA radio unit 102, the chip rate of pseudo noise code has been set at 4.096 Mcps (cycles per second). The radio unit 102 has employed the QPSK (quadrature phase shift keying) method as the primary modulation method.

Under the control of a control unit 100, a voltage control unit 103 controls the gain of the amplifier in the W-CDMA radio unit 102. With this control, the transmission level of the CDMA signal transmitted to a base station BS is controlled.

A BT radio unit 105 transmits a radio signal to a personal computer or an EC-system-compatible unit by the BT radio communication, and receives a radio signal from a personal computer or an EC-system-compatible unit by means of the BT radio communication. An antenna 104 is provided to transmit and receive a radio signal based on the BT radio communication.

A speech codec unit 106 codes the transmitted speech signal input from a microphone 107, the signal being based on a specific speech coding method, and decodes the received signal input through the control unit 100 from the W-CDMA radio unit 102 into a received speech signal. Then, a loudspeaker 108 amplifies and outputs the received speech signal.

An image processing unit 109 has used a CCD (charge-coupled device) or CMOS (complementary metal-oxide semiconductor) solid-state imaging device, and subjects a image signal picked by a camera 110 to an image process, such as coding. (In an image processing unit 109, CCD or CMOS solid-state imaging device is used. In this unit 109, an image process that codes an image signal picked by a camera 110 is implemented.) The image process converts the image signal into a form that can be used in television (TV) telephone communication or image data communication using the W-CDMA radio communication. This converted signal is input to the control unit 100.

At the same time, the image processing unit 109 decodes the received image data or the image data stored in a memory 113. Then, this decoded image is displayed on a display unit 111, such as an LCD (liquid crystal display).

An operating unit 112 is a key input unit composed of calculator keys, cursor keys, and various function keys. The operating unit 112 is used for not only ordinary outgoing and incoming calls but also the scrolling of the information displayed on the display unit 111, and instructions to the called party.

The memory 113 is composed of a semiconductor memory, such as a RAM (random-access memory) or a ROM (read-only memory). The memory 113 stores a control program for the control unit 100 explained later. In addition, the memory 113 is used to store the data that should be transmitted or the received data in the W-CDMA radio communication or BT radio communication, the use history data or purchase history data of EC-system-compatible units, and the menu information acquired from these units.

An UIM card 114 is a memory card that can be inserted into and removed from the mobile radio apparatus. The UIM card 114 stores not only information to access a W-CDMA radio communication system, such as identification information on users, but also information on electronic money withdrawn from a bank via a network, such as a public telecommunication network, or code numbers for electronic money.

The control unit 100 supervises control of each unit of the mobile radio apparatus. With this control, various types of radio communication by the W-CDMA radio communication or by the BT radio communication, or control related to EC are implemented.

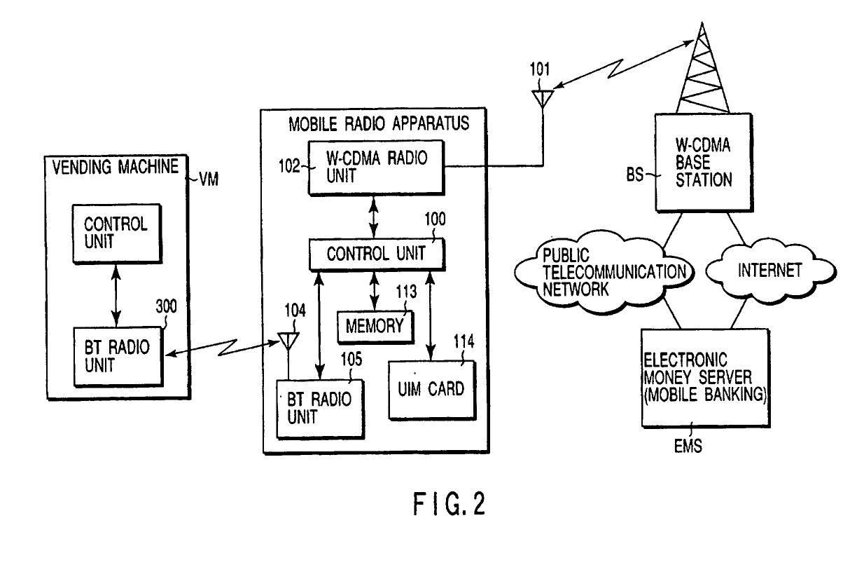

The following is an explanation of the operation in a case where information on electronic money is loaded by means of the mobile radio apparatus into the UIM card 114 from an electronic money server managed and operated by a bank or the like, as shown in FIG. 2. FIG. 2 shows a system configuration of a case where EC is conducted using the mobile radio apparatus shown in FIG. 1.

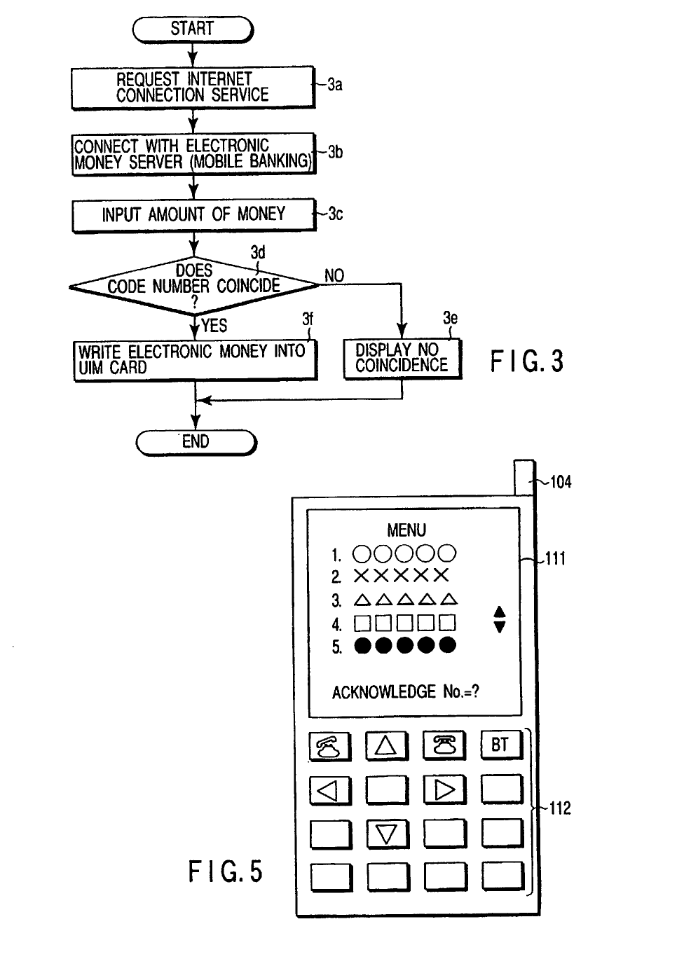

In waiting for an incoming call, when the user operates the operating unit 112 of the mobile radio apparatus and makes a request for internet connection service given by a communication provider, the process shown in FIG. 3 is started. FIG. 3 is a flowchart for the process of conducting EC by use of the mobile radio apparatus shown in FIG. 1. The series of operations shown in FIG. 3 is carried out by the control unit 100.

At a step 3a, the mobile radio apparatus and the base station BS are connected to each other via radio channels. A request for use of internet connection service is made, and then the step of this process proceeds to a step 3b. As a result, internet connection service is started, which connects the mobile radio apparatus to an internet server (not shown) that the communication provider has.

At a step 3b, mobile banking is selected from the menu information provided by the internet server. Connection to an electronic money server EMS is requested and the step of this process proceeds to a step 3c. This establishes a communication link between the mobile radio apparatus and the electronic money server EMS.

At a step 3c, a message to ask the user how much money the user wants to withdraw in the form of electronic money appears on the display unit 111, prompting the user to enter the amount of money that should be withdrawn. Then, numbers of the amount of money, which causes a request for the withdrawal of the input amount of money to be transmitted to the electronic money server EMS, are input to the mobile radio apparatus. Thereafter, the step of this process proceeds to a step 3d.

At a step 3d, a message to ask the user to enter a required code number into the electronic money server EMS appears on the display unit 111, prompting the user to enter this code number. Then, this input code number is transmitted to the electronic money server EMS. It is decided whether the electronic money server EMS has given the answer that the input code number coincides with the authentic one.

If the electronic money server EMS supplies the answer that the input code number coincides with the authentic one, the step of this process proceeds to a step 3f. In contrast, if the electronic money server EMS supplies the answer that the input code number does not coincide with the authentic one, the step of this process will proceeds to a step 3e. At a step 3e, a message to inform the user that the input code number is not correct appears on the display unit 111 and this process is ended.

At a step 3f, a withdrawal-permitting signal from the electronic money server EMS is received. Thereafter, information on the amount of electronic money to be withdrawn requested at a step 3c is recorded in the UIM card 114, and then this process is ended.

Thereafter, the amount of money requested is withdrawn from a preset bank account at the preset date.

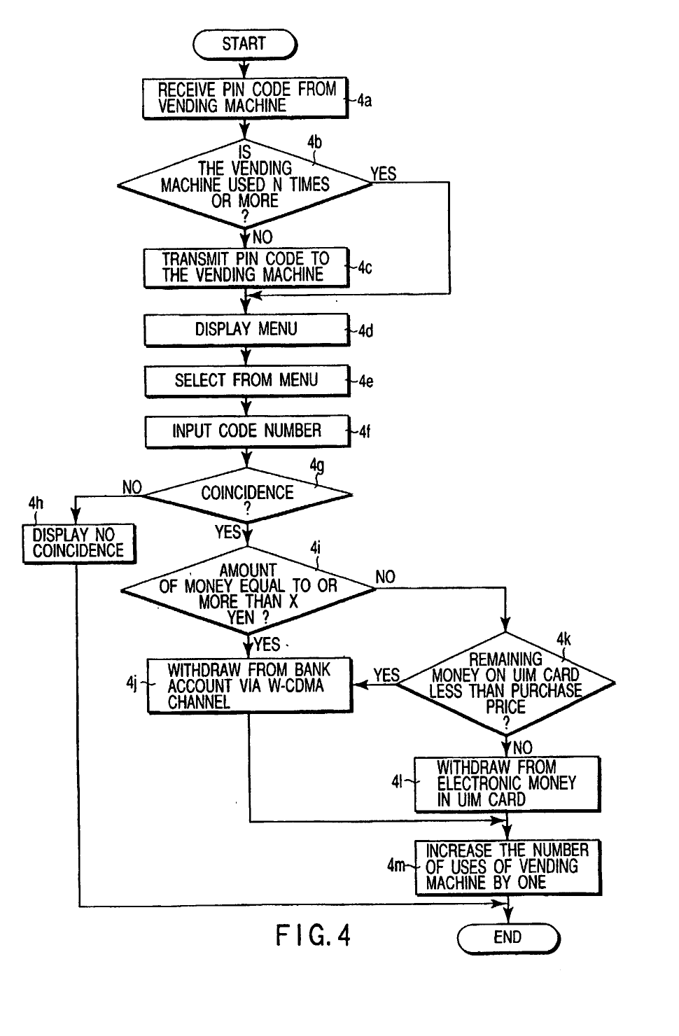

The following is an explanation of the operation in a case where a commodity is purchased by use of the mobile radio apparatus from a vending machine compatible with an EC system. FIG. 4 is a flowchart for the process of carrying out the operation of the mobile radio apparatus in a case where the user of the mobile radio apparatus purchases a commodity from a vending machine VM. The operation of FIG. 4 is implemented by the control unit 100.

In waiting for an incoming call, when the user with the mobile radio apparatus approaches the vending machine VM, the BT radio unit 105 receives, via the antenna 104, the radio signal transmitted from the BT radio unit 300 of the vending machine VM. When the radio signal is received, the process of FIG. 4 is started.

At a step 4a, the BT radio unit 105 receives the radio signal transmitted from the BT radio unit 300 of the vending machine VM and acquires the PIN code of the vending machine VM. Then, the step of this process proceeds to a step 4b.

At a step 4b, the number of times that the unit corresponding to the PIN code received at a step 4a was used is referred to the history data stored in the memory 113, the history data being indicating the time when the mobile radio apparatus communicates an EC-system-compatible apparatus. In other words, the history data indicates the number of transactions conducted with the BT radio unit 300 capable of conducting electronic commerce through the BT radio unit 105. Then, it is decided whether the number of uses is equal to or larger than a preset number of N times (for example, ten times).

If the number of uses is equal to or larger than N times, the step of this process proceeds to a step 4d. In contrast, if the number of uses is smaller than N times, the step of this process proceeds to a step 4c.

At a step 4c, the PIN code of the vending machine VM is sent back through the BT radio unit 105 to the vending machine VM. Then, the menu information transmitted from the vending machine VM in response to this PIN code is received in the BT radio unit 105 and, thereafter, the step of this process proceeds to a step 4d.

At a step 4d, when the menu information is received from the vending machine VM at a step 4c, the information is displayed on the display unit 111. on the other hand, when the number of uses is equal to or larger than N times, the menu information for the vending machine VM stored in the memory 113 is shown on the display unit 111. Thereafter, the step of this process proceeds to a step 4e.

FIG. 5 shows the representation at a step 4d. The order in which the menu is displayed may be in the order of identification numbers of commodities dealt with or the order of frequency of purchase based on the history data of purchasing commodities.

At a step 4e, as the user operates the operating unit 112, the information appearing on the display unit 111 is scrolled or the selection of a menu is accepted in the mobile radio apparatus. Then, the selection of the commodity the user wants to purchase is accepted in the mobile radio apparatus and the step of this process a step 4f.

At a step 4f, a message to prompt the user to enter the code number appears on the display unit 111. The input of the code number is implemented by means of the operating unit 112. After the code number has been entered in the mobile radio apparatus, the step of this process proceeds to a step 4g.

At a step 4g, it is decided whether the code number input at a step 4f coincides with the electronic money code number stored in the UIM card 114. If the input code number coincides with the electronic money code number, the step of this process proceeds to a step 4i.

In contrast, if the input code number does not coincide with the electronic money code number, the step of this process proceeds to a step 4h. Thereafter, a message indicating that the input code number is not correct appears on the display unit 111, and then this process is ended.

At a step 4i, it is decided whether the price of the commodity at a step 4e is equal to or higher than the preset amount of money, X yen. If the price of the commodity the user wants to purchase is equal to or higher than X yen (for example, 10,000 yen), the step of this process will proceed to a step 4j. In contrast, if the price is lower than X yen, the step of this process proceeds to a step 4k.

At a step 4j, the mobile radio apparatus is connected to the electronic money server EMS through the base station BS and public telecommunication network. Information on the necessary amount of electronic money to purchase the commodity is taken out from the bank account corresponding to the user's identification information to be recorded in the UIM card 114 and information on the withdrawn electronic money is recorded in the UIM card 114.

Then, the BT radio unit 105 is controlled and the identification number of the commodity and the electronic money information corresponding to the price of the commodity are transmitted to the vending machine VM. On the other hand, the vending machine VM receives the electronic money information from the mobile radio apparatus and is paid by the electronic money. After having received the payment, the vending machine VM delivers the requested commodity to the outlet and sends back to the mobile radio apparatus, information on the acceptance of selling the commodity.

Then, after the mobile radio apparatus receives information on the acceptance of selling the commodity from the vending machine VM, information on the electronic money corresponding to the amount of user's dues is subtracted from the UIM card 114, and then this process is ended.

Information on the electronic money in a step 4j may be withdrawn collectively in a midnight time zone during which the communication traffic is low and the communication rate is low. Moreover, it may be withdrawn collectively after a preset amount of money used in shopping is paid, or on a preset date for paying money used in shopping.

At a step 4k, it is decided whether the remaining electronic money stored in the UIM card 114 is smaller than the price of the commodity the user wants to purchase. If the remaining electronic money stored in the UIM card 114 is smaller than the price of the commodity the user wants to purchase, the step of this process proceeds to a step 4j. In contrast, if the remaining electronic money stored in the UIM card 114 is equal to or larger than the price of the commodity the user wants to purchase, the step of this process proceeds to a step 41.

At a step 41, the BT radio unit 105 is controlled and the identification number of the commodity and the electronic money information corresponding to the price of the commodity are transmitted to the vending machine VM. When the vending machine VM receives the electronic money information and the payment in electronic money from the mobile radio apparatus is implemented, the vending machine VM delivers the requested commodity from its outlet and sends back to the mobile radio apparatus, information on the acceptance of selling the commodity.

When the mobile radio apparatus receives information on the acceptance of selling the commodity, information on the electronic money corresponding to the amount of user's dues is subtracted from the UIM card 114, and the step of this process proceeds to a step 4m.

At a step 4m, the number of purchases is increased by one, as the number being recorded the history data of using the vending machine in such a manner that the number is based on the PIN code of the vending machine. At this time, when the number of purchases reaches the aforementioned N times, the menu information acquired from the vending machine VM is caused to correspond to the PIN code and then stored in the memory 113, and then this process is ended.

As described above, in the mobile radio apparatus with the above configuration, information on electronic money is withdrawn into the UIM card 114 via the W-CDMA communication network. In addition, a commodity may be purchased by means of communication with an EC-system-compatible unit by the BT radio communication less affected by obstruction than infrared-ray communication by the IrDA method.

Therefore, the mobile radio apparatus with the above configuration enables withdrawal of information on electronic money and EC by the BT radio communication immune to obstruction, which improves the user's convenience in conducting EC.

When a commodity priced at low level is purchased by means of the mobile radio apparatus with the above configuration, payment using the UIM card 114 has priority over withdrawal of information on electronic money from the bank account using the W-CDMA radio channel. Consequently, when a commodity priced at low level, as a result there is strong possibility that the mobile radio apparatus is implemented, is purchased, the communication expenses for using the W-CDMA radio channel may be suppressed.

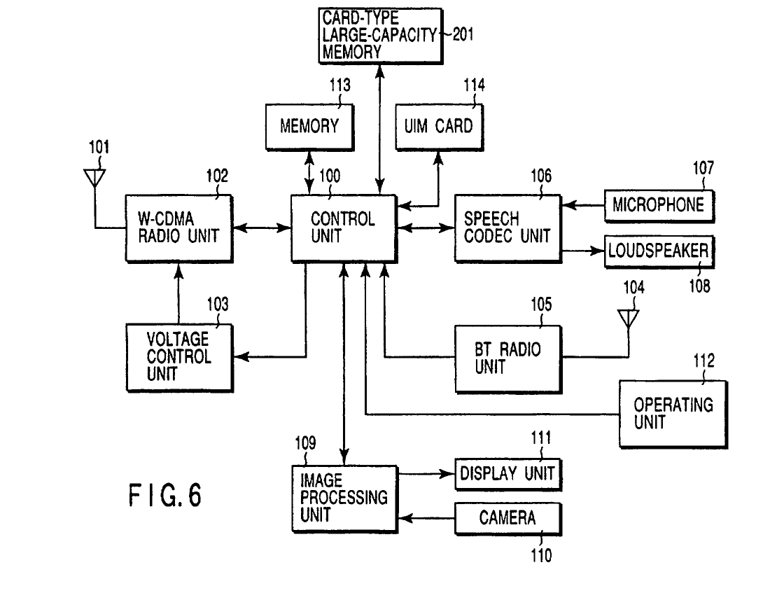

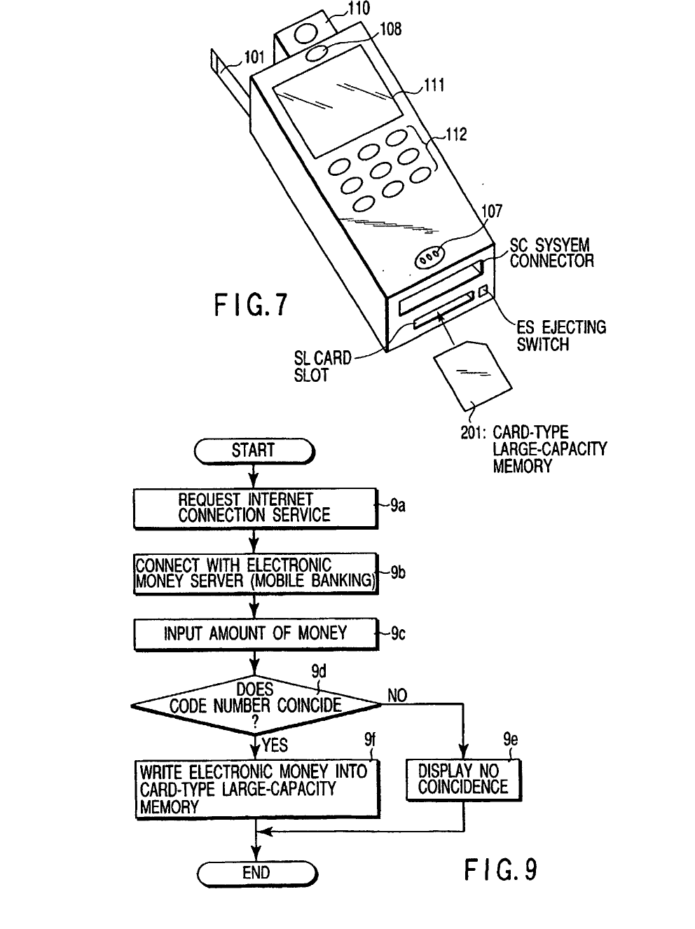

Hereinafter, a mobile radio apparatus according to a second embodiment of the present invention will be explained. FIG. 6 shows the configuration of the mobile radio apparatus according to the second embodiment. In FIG. 6, the same units as those in FIG. 1 showing the configuration of the mobile radio apparatus of the first embodiment are indicated by the same reference numerals. Explanation will be focused on the units shown in FIG. 6 differing from those shown in FIG. 1. FIG. 7 shows an example of inserting a card-type large-capacity memory into the mobile radio apparatus shown in FIG. 6.

A card-type large-capacity memory 201 is a memory card that can be inserted into and removed from the mobile radio apparatus and that has a different standard from that for the UIM card 114. The card-type large-capacity memory 201 is set at, for example, the bottom of the mobile radio apparatus as shown in FIG. 7. Specifically, the card-type large-capacity memory 201 is inserted into the mobile radio apparatus in a card slot SL provided in parallel with a system connector SC for executing various controls and is electrically connected. Operating an ejecting switch ES enables the card-type large-capacity memory 201 to be removed from the mobile radio apparatus.

A control unit 200 supervises control of each unit of the mobile radio apparatus. With this control, various types of radio communication by the W-CDMA radio communication or by the BT radio communication are implemented. In other case control related to EC is implemented.

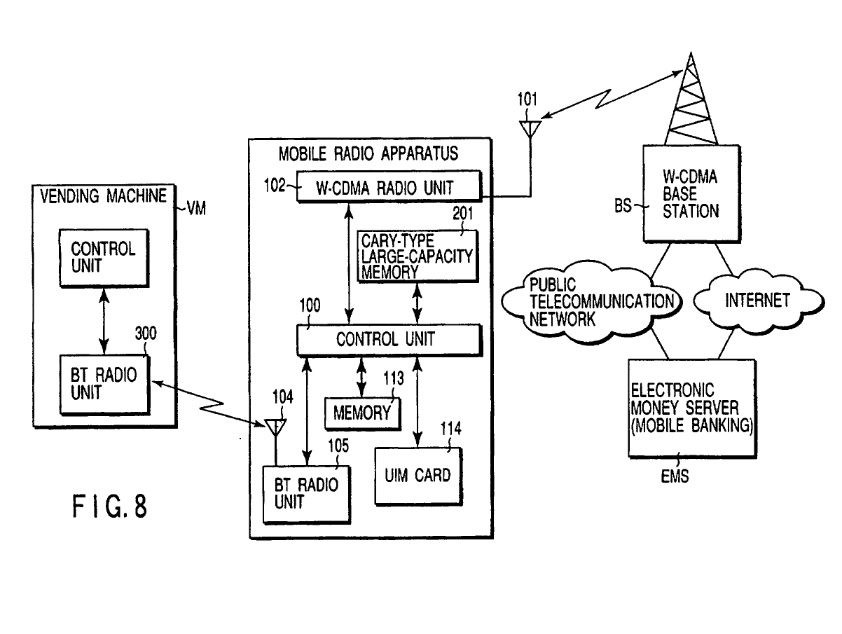

The following is, in reference to FIG. 8, an explanation of the operation in a case where information on electronic money is loaded by the mobile radio apparatus from an electronic money server EMS managed and operated by a bank or the like into the card-type large-capacity memory 201. FIG. 9 is a flowchart for the process of implementing the operation in a case where information on electronic money is loaded by the mobile radio apparatus from the electronic money server shown in FIG. 8 into the card-type large-capacity memory. The operation shown in FIG. 9 is carried out by the control unit 200.

In waiting for an incoming call, when the user operates the operating unit 112 of the mobile radio apparatus and makes a request for internet connection service given by a communication provider, the process shown in FIG. 9 is started.

At a step 9a, the mobile radio apparatus and the base station BS are communicated over a radio channel. A request for use of internet connection service is made, and then the step of this process proceeds to a step 9b. As a result, internet connection service is started, which connects the mobile radio apparatus to an internet server (not shown) the communication provider has.

At a step 9b, mobile banking is selected from the menu information provided by the internet server. Connection to an electronic money server EMS is requested and the step of this process proceeds to a step 9c. This mobile banking establishes a communication link between the mobile radio apparatus and the electronic money server EMS.

At a step 9c, a message to ask the user how much money the user wants to withdraw in the form of electronic money appears on the display unit 111, prompting the user to enter the amount of money that should be withdrawn. Then, the user enters the amount of money that should be withdrawn, which causes a request for the withdrawal of the input amount of money that should be transmitted to the electronic money server EMS. Thereafter, the step of this process proceeds to a step 9d.

At a step 9d, a message to ask the user to enter the required code number into the electronic money server EMS appears on the display unit 111, prompting the user to enter the code number. Then, the input code number is transmitted to the electronic money server EMS. It is decided whether the electronic money server EMS supplies the answer that the input code number coincides with the authentic one.

If the electronic money server EMS supplies the answer that the input code number coincides with the authentic one, the step of this process proceeds to a step 9f. In contrast, if the electronic money server EMS supplies the answer that the input code number does not coincide with the authentic one, the step of this process proceeds to a step 9e. At a step 9e, a message to inform the user that the input code number is not correct appears on the display unit 111 and this process is ended.

At a step 9f, a withdrawal-permitting signal from the electronic money server EMS is received. Thereafter, information on the amount of electronic money to be withdrawn requested at a step 9c is recorded in the card-type large-capacity memory 201, and then this process is ended.

Thereafter, the amount of money requested is withdrawn from the bank account at a preset date.

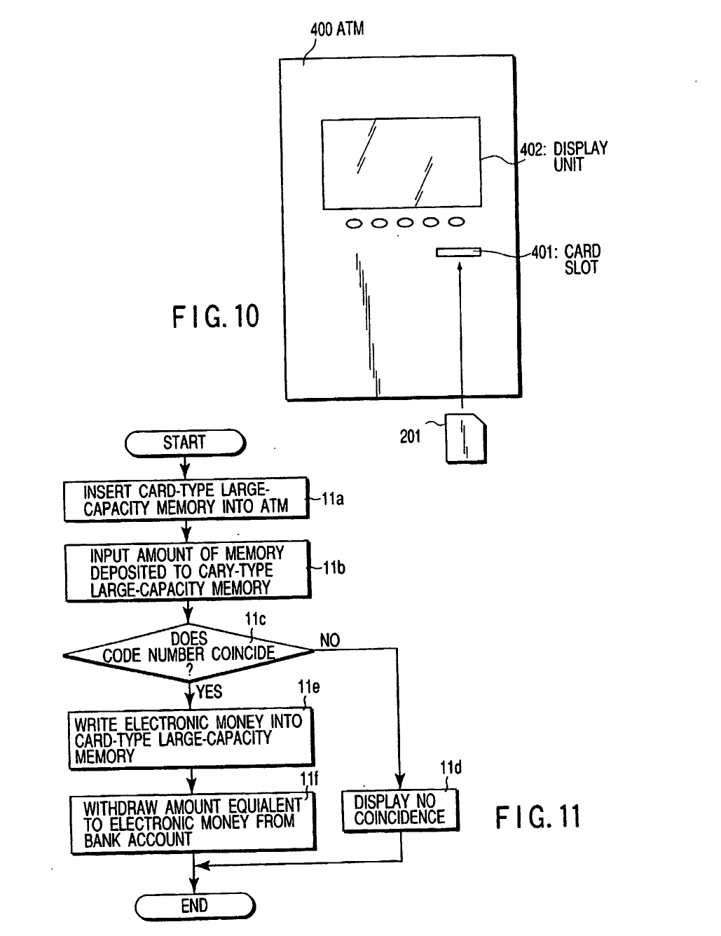

The following is an explanation of the operation in a case where information on electronic money is loaded from an ATM (automated teller machine) 400 capable of inputting money into and outputting money from the card-type large-capacity memory 201 in the form of electronic money as shown in FIG. 10. FIG. 10 is an illustration showing how the card-type large-capacity memory shown in FIG. 7 is inserted into an ATM capable of inputting and outputting money in the form of electronic money. FIG. 11 is a flowchart showing the steps in the processes in the ATM shown in FIG. 10.

At a step 11a, when the card-type large-capacity memory 201 is inserted into the card slot 401 in the ATM 400, the card-type large-capacity memory 201 is sensed and the step of this process proceeds to a step 11b.

At a step 11b, a message to ask the user to enter the number of the user's bank account and the amount of money the user wants to withdraw appears on the display unit 402, prompting the user to enter the bank account number and the amount of money. After it is detected that they have been entered, the step of this process proceeds to a step 11c.

At a step 11c, a message to ask the user to enter the code number appears on the display unit 402, prompting the user to enter the code number. Then, it is decided whether the input code number coincides with the number registered in such a manner that it corresponds to the bank account number.

If the input code number coincides with the registered number, the step of this process proceeds to a step 11e. In contrast, if the input code number does not coincide with the registered number, the step of this process proceeds to a step 11d. At a step 11d, a message that the input code number is not correct appears on the display unit 402, and then this process is ended.

At a step 11e, information on the requested amount of electronic money withdrawn is recorded in the card-type large-capacity memory 201. This card is then ejected and the step of this process proceeds to a step 11f.

At a step 11f, the amount of money recorded in the card-type large-capacity memory 201 is subtracted from the bank account input at a step 11b, and then this process is ended.

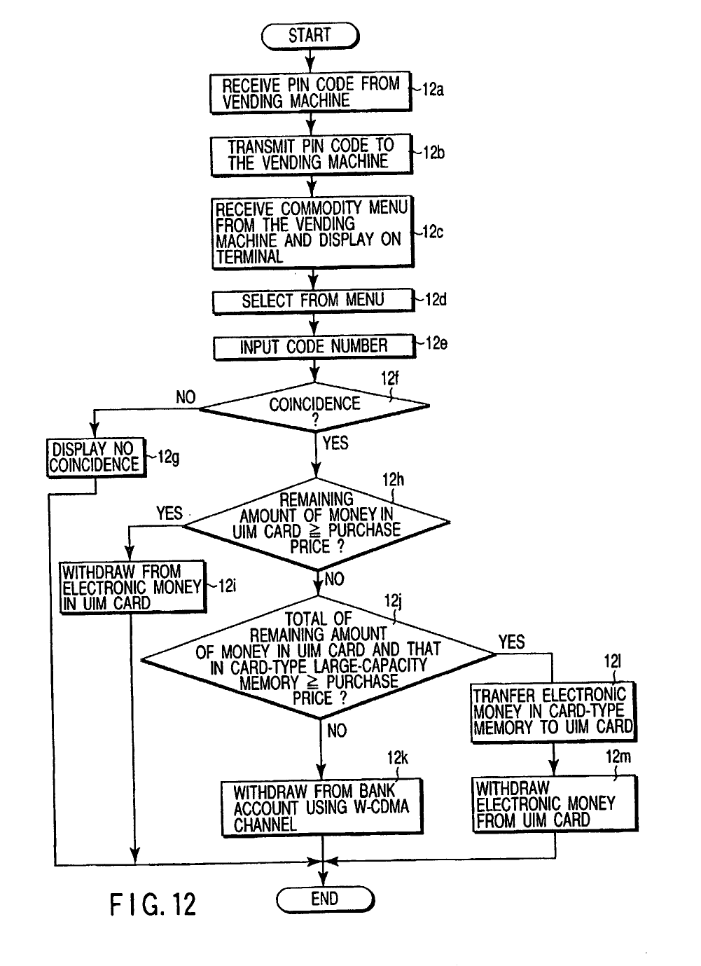

The following is an explanation of the operation in a case where a commodity is purchased by means of the mobile radio apparatus from a vending machine compatible with an EC system. FIG. 12 is a flowchart for the process of carrying out the operation of the mobile radio apparatus in a case where the user of the mobile radio apparatus purchases a commodity from the vending machine shown in FIG. 8. The operation shown in FIG. 12 is implemented by the control unit 200.

In waiting for an incoming call, when the user with the mobile radio apparatus approaches the vending machine VM and the BT radio unit 105 receives, via the antenna 104, the radio signal transmitted from the BT radio unit 300 of the vending machine VM, the process shown in FIG. 12 is started.

At a step 12a, the BT radio unit 105 receives the radio signal transmitted from the BT radio unit 300 of the vending machine VM and receives the PIN code of the vending machine VM. Then, the step of this process proceeds to a step 12b.

At a step 12b, the PIN code of the vending machine VM is sent back through the BT radio unit 105 to the vending machine VM and the step of this process proceeds to a step 12c.

At a step 12c, in response to the PIN code sent back at a step 12b, the menu information transmitted from the vending machine VM is received in the mobile radio apparatus. The information appears on the display unit 111 and the step of this process proceeds to a step 12d.

At a step 12d, as the user operates the operating unit 112, the information appearing on the display unit 111 is scrolled, or the selection of a menu is accepted in the mobile radio apparatus. Then, the selection of the commodity the user wants to purchase is accepted and the step of this process proceeds to a step 12e.

At a step 12e, a message to prompt the user to enter the code number appears on the display unit 111. The code number is input by use of the operating unit 112. After the code number is entered, the step of this process proceeds to a step 12f.

At a step 12f, it is decided whether the code number input at a step 12e coincides with the electronic money code number stored in the UIM card 114. If the input code number coincides with the electronic money code number, the step of this process proceeds to a step 12h.

In contrast, if the input code number does not coincide with the electronic money code number, the step of this process proceeds to a step 12g. Then, a message that the input code number is not correct appears on the display unit 111, and then this process is ended.

At a step 12h, it is decided whether the remaining electronic money stored in the UIM card 114 is equal to or larger than the price of the commodity the user wants to purchase. If the remaining electronic money stored in the UIM card 114 is smaller than the price of the commodity the user wants to purchase, the step of this process proceeds to a step 12j. In contrast, if the remaining electronic money stored in the UIM card 114 is equal to or larger than the price of the commodity the user wants to purchase, the step of this process proceeds to a step 12i.

At a step 12i, the BT radio unit 105 is controlled and the identification number of the commodity and the electronic money information corresponding to the price of the commodity are transmitted to the vending machine VM. When the vending machine VM receives the electronic money information and the payment in electronic money from the mobile radio apparatus, the vending machine VM delivers the requested commodity from its outlet and sends back to the mobile radio apparatus, information on the acceptance of selling the commodity.

When the mobile radio apparatus has received information on the acceptance of selling the commodity, information on the electronic money corresponding to the amount of user's dues is subtracted from the UIM card 114, and then this process is ended.

At a step 12j, it is decided whether the total of the remaining electronic money stored in the UIM card 114 and the remaining electronic money stored in the card-type large-capacity memory 201 is equal to or larger than the price of the commodity the user wants to purchase. If the total is smaller than the price of the commodity the user wants to purchase, the step of this process proceeds to a step 12k. In contrast, if the total is equal or larger than the price of the commodity the user wants to purchase, the step of this process proceeds to a step 121.

At a step 12k, the W-CDMA radio unit 102 is controlled and the mobile radio apparatus is connected to the electronic money server EMS through the base station BS and public telecommunication network. Then, information on the electronic money equivalent to a deficit to purchase the commodity is withdrawn from the bank account corresponding to the user's identification information to be recorded in the UIM card 114. Then, the withdrawn information on electronic money is recorded in the UIM card 114.

Then, the BT radio unit 105 is controlled, and the identification number of the commodity and the electronic money information corresponding to the price of the commodity are transmitted to the vending machine VM. On the other hand, the vending machine VM receives the electronic money information from the mobile radio apparatus and then the electronic money is paid to the vending machine. After having received the payment, the vending machine VM delivers the requested commodity from its outlet and sends back to the mobile radio apparatus, information on the acceptance of selling the commodity.

Then, after the mobile radio apparatus receives information on the acceptance of selling the commodity from the vending machine VM, information on the electronic money corresponding to the amount of user's dues is subtracted from the UIM card 114, and then this process is ended.

At a step 121, the remaining electronic money stored in the card-type large-capacity memory 201 is added to the remaining electronic money stored in the UIM card 114. In addition, the remaining electronic money stored in the card-type large-capacity memory 201 is subtracted and the step of this process proceeds to a step 12m.

At a step 12m, the BT radio unit 105 is controlled, and the identification number of the commodity and the electronic money information corresponding to the price of the commodity are transmitted to the vending machine VM. When receiving the electronic money information and the payment in electronic money from the mobile radio apparatus, the vending machine VM delivers the requested commodity from its outlet and sends back to the mobile radio apparatus, information on the acceptance of selling the commodity.

Then, when the mobile radio apparatus receives information on the acceptance of selling the commodity, information on the electronic money corresponding to the amount of user's dues is subtracted from the UIM card 114, and then this process is ended.

As described above, in the mobile radio apparatus with the above configuration, information on electronic money is loaded into the UIM card 114 via the W-CDMA communication network. In addition, a commodity may be purchased by means of communication with an EC-system-compatible unit by the BT radio communication less affected by obstruction than infrared-ray communication by the IrDA method.

When the remaining electronic money stored in the UIM card 114 is not enough to purchase the commodity, this remaining electronic money is added to the remaining electronic money stored in the card-type large-capacity memory 201, thereby paying money for the commodity.

Therefore, the mobile radio apparatus with the above configuration enables withdrawal of information on electronic money and EC by the BT radio communication immune to obstructions. When the electronic money stored in the UIM card 114 is not enough, this electronic money may be added to the electronic money stored in the card-type large-capacity memory 201 to purchase a commodity, which increases the user's convenience in conducting EC.

The present invention is not limited to the above embodiments. For instance, in the embodiments, the electronic money stored in the UIM card 114 has priority in use and payment. Instead of this priority, the electronic money stored in the card-type large-capacity memory 201 has priority in use and payment. Moreover, when the electronic money stored in the card-type large-capacity memory 201 is not enough, the electronic money stored in the UIM card 114 is transferred to the card-type large-capacity memory 201 to enable the desired commodity of user to be purchased.

Furthermore, in the embodiments, information on electronic money may be loaded into the UIM card 114 via the W-CDMA communication network. Instead of this, information on electronic money may be withdrawn from an ATM or the like and stored in the UIM card 114.

Here, the card-type large-capacity memory 201, an external storage medium, explained in the embodiments, is capable of reading or writing information on electronic money. Therefore, it is desirable that the card-type large-capacity memory 201 should be a large-capacity storage medium capable of setting copy protection to make it very difficult for a third party to read or copy the information. The present invention, however, is not restricted to this type of storage device.

As described above, according to the present invention, the called party capable of conducting EC is connected directly to the called party's station by radio channels through the second communication means. Information on electronic money is transmitted via radio contact, thereby making payments in electronic money.

Therefore, according to the present invention, since EC can be conducted with the second communication means that communicates directly with the called party over radio channels having low radio transmission power, there is not strong possibility that communication is disturbed by obstruction in a case of infrared rays are used. This makes it possible to provide a mobile radio apparatus capable of improving the user's convenience in conducting EC.

Furthermore, according to the present invention, the called party capable of conducting EC through the second communication means that communicates directly with the called party's station over radio channels having low radio transmission power is connected to the called party's station. Information on electronic money stored in at least either the first electronic money storage means or second electronic money storage means is, via radio contact, transmitted to the called party, thereby making payments in electronic money.

Therefore, with the invention, since EC can be conducted by means of the second communication means that communicates directly with the called party's station over radio channels having low radio transmission power, communication is less liable to be affected by obstruction in case of infrared rays are used. In addition, since payments are made based on at least one of the pieces of information on the electronic money stored in the two different storage means, it is possible to provide a mobile radio apparatus capable of improving the user's convenience in conducting EC.

Furthermore, the present invention may be practiced or embodied in still other ways without departing from the spirit or essential character thereof.

### INDUSTRIAL APPLICABILITY

As described above, the present invention is effective in the field of radio contact between the called party capable of conducting EC and the called party's station, and the field of making business transactions in electronic money by transmitting information on electronic money via radio channels.

1. A mobile radio apparatus for communicating over a radio channel with a base station connectable to a network for communication, comprising:
first communication means for communicating indirectly over a radio channel with a communication apparatus to be communicated through a base station;
second communication means for communicating directly over a radio channel with a communication apparatus using radio waves of lower radio transmission power than said first communication means; and
electronic money payment means for transmitting information on electronic money to the communication apparatus, and for making payments in electronic money, said electronic money payment means communicating with the communication apparatus capable of conducting electronic commerce by said second communication means.

2. The mobile radio apparatus according to claim 1, wherein said first communication means acquires information on electronic money from the communication apparatus.

3. The mobile radio apparatus according to claim 2, further comprising electronic money information storage means for storing the information on electronic money.

4. The mobile radio apparatus according to claim 3, wherein the information on electronic money acquired from the communication apparatus is stored in said electronic money information storage means.

5. The mobile radio apparatus according to claim 3, wherein said electronic money payment means pays the information on electronic money stored in said electronic money information storage means to the communication apparatus by said second communication means.

6. The mobile radio apparatus according to claim 1, wherein said second communication means communicates by means of Bluetooth radio communication.

7. The mobile radio apparatus according to claim 1, further comprising menu information acquisition means for acquiring menu information which indicates contents of service supplied over radio channels by the communication apparatus, said menu information acquisition means communicating with the communication apparatus capable of conducting electronic commerce through said second communication means.

8. The mobile radio apparatus according to claim 1, further comprising:
number-of-transactions storage means for storing, for each of the communication apparatus, the number of transactions conducted with the communication apparatus capable of conducting electronic commerce through said second communication means; and
menu information storage means for storing menu information for the communication apparatus with the number of the transactions stored in said number-of-transactions storage means equal to or larger than a preset value.

9. The mobile radio apparatus according to claim 8, further comprising:
number-of-transactions deciding means for deciding whether the number of transactions with the communication apparatus communicated by means of radio is equal to or larger than a preset value, owing to reference to information stored in said number-of-transactions storage means, when said second communication means communicates by means of radio with said communication apparatus capable of conducting electronic commerce; and
display means for displaying the menu information for the communication apparatus stored in said menu information storage means, when said number-of-transactions deciding means decides that the number of transactions is equal to or larger than the preset value.

10. The mobile radio apparatus according to claim 1, further comprising electronic money information storage means for storing information on electronic money.

11. The mobile radio apparatus according to claim 10, wherein said electronic money information storage means stores subscriber's information with which communication by said first communication means can be established.

12. The mobile radio apparatus according to claim 10, wherein said electronic money information storage means is removable.

13. The mobile radio apparatus according to claim 10, wherein, in a case where electronic money is paid to the communication apparatus,
when an amount of the electronic money is equal to or larger than a preset amount of electronic money and larger than a remaining amount of electronic money, a corresponding amount of the electronic money is withdrawn from a bank account by use of said first communication means, and
when an amount of the electronic money is less than the preset amount of electronic money and equal to or less than a remaining amount of electronic money, a corresponding amount of the electronic money is withdrawn from said electronic money information storage means.

14. A mobile radio apparatus for communicating over a radio channel with a base station connectable to a network for communication, comprising:
first communication means for communicating indirectly over a radio channel with a communication apparatus to be communicated through a base station, said first communication means communicating with the base station;
second communication means for communicating directly over a radio channel with a communication apparatus using lower radio transmission power than said first communication means;
first electronic money storage means for storing information on electronic money, and for storing subscriber's information with which communication by said first communication means can be established;
second electronic money storage means for storing information on electronic money, said second electronic money storage means storing the information with a different standard from a standard of said first electronic money storage means; and
electronic money payment means for transmitting the information on electronic money stored in at least one of said first electronic money storage means and second electronic money storage means to the communication apparatus, and for making payments in electronic money, said electronic money payment means communicating with the communication apparatus capable of conducting electronic commerce by said second communication means.

15. The mobile radio apparatus according to claim 14, wherein said first communication means acquires information on electronic money from the communication apparatus, and stores the information on electronic money in said first and second electronic money storage means.

16. The mobile radio apparatus according to claim 14, wherein said second electronic money storage means is removable.

17. The mobile radio apparatus according to claim 14, further comprising electronic money transfer means for transferring information on electronic money between said first electronic money storage means and said second electronic money storage means.

18. The mobile radio apparatus according to claim 14, further comprising electronic money withdrawal means for withdrawing information on electronic money through at least one of said first communication means and said second communication means, and for storing the information in said second storage means.

19. The mobile radio apparatus according to claim 14, wherein said electronic money payment means pays the information on electronic money stored in at least one of said first electronic money storage means and second electronic money storage means to the communication apparatus by said second communication means.

20. The mobile radio apparatus according to claim 14, wherein, in a case where electronic money is paid to the communication apparatus,
when an amount of the electronic money is equal to or less than an amount of the electronic money in said first electronic money storage means, information on electronic money is withdrawn from said first electronic money storage means, and
when an amount of the electronic money is greater than an amount of the electronic money in said first electronic money storage means and is equal to or less than a total amount of the electronic money in said first electronic money storage means and the electronic money in said second electronic money storage means, information on electronic money is transferred from said second electronic money storage means to said first electronic money storage means, and information on electronic money is withdrawn from said first electronic money storage means.
